(19) United States
(12) Patent Application Publication
(10) Pub. No.: US 2008/0257962 A1
(43) Pub. Date: Oct. 23, 2008

(54) ACCELERATION-CORRECTED BARCODE VERIFICATION

(76) Inventor: Lihu M. Chiu, Arcadia, CA (US)

Correspondence Address: Jonathan W. Hallman;MacPHERSON KWOK CHEN & HEID LLP, Ste. 400, 2033 Gateway Place, San Jose, CA, 95110, US

(21) Appl. No.: 11/738,611

(22) Filed: Apr. 23, 2007

(51) Int. Cl. G06K 7/10

(52) U.S. Cl. 235/462.16

(57) ABSTRACT

In one embodiment, barcode widths and barcode space widths are estimated using a first light source separated by a known distance from a second light source. The estimations are determined by scanning the first and second light sources over a barcode while detecting a corresponding first reflected light beam and a second reflected light beam from the scanned barcode; processing the first reflected light beam to determine first barcode edge detections; processing the second reflected light beam to determine second barcode edge detections; estimating a first acceleration for the scanning; estimating a second acceleration for the scanning, wherein the second acceleration is substantially orthogonal to the first acceleration; deriving an overall velocity for the scanning by integrating the first and second accelerations; and comparing the first edge detections to the second edge detections using the overall velocity to derive the barcode widths and spaces.

### TECHNICAL FIELD

This disclosure relates to barcode scanning. More particularly, this disclosure relates to acceleration-corrected barcode verification.

### BACKGROUND

Barcodes are essential to modern commerce. Virtually all commercially available items receive barcode identification. Consumers, manufacturers, and retailers all benefit from their use because it is the least expensive yet most reliable way of providing machine-readable information. Given how pervasive barcoding has become for modern commerce, various “barcode verification” schemes have been developed to characterize the quality of a barcode label. For example, with regard to one-dimensional barcodes, the Uniform Code Council (UCC) has promulgated nine separate categories of barcode quality. To ascertain the quality in these categories, a barcode verifier scans a light beam across a barcode.

In a conventional barcode verifier, the light beam is focused into a generally circular illumination spot on the barcode. This illumination spot scans across a “slice” of the barcode during the verification in a direction generally normal to the longitudinal axis of the bars in the barcode. Although a single illumination spot can be used to detect the contrast between the printed bars and the imprinted media between the bars, barcode verification also is related to the widths of the bars as well as the width of the imprinted media strips between the bars. To provide such measurements, barcode verifiers typically use two light beams that are separated by a known distance. In this fashion, the corresponding illumination spots are also separated by this known distance. In general, the barcode verifier will be aligned with the barcode such that the linear separation between the illumination spots is normally directed to the longitudinal axis of the bars in the barcode. Consider the interaction of such a barcode verifier as it begins to scan a barcode, starting from a first bar to a last bar as seen in FIG. 1. A first one of the illumination spots will initially detect an initial edge of the first bar. As the barcode verifier scans across the barcode, a remaining second one of the illumination spots will subsequently detect the initial edge of the first bar. Similarly, the first illumination spots will also initially detect the trailing edge of the first bar, which is then subsequently detected by the second illumination spot.

The barcode verifier has a detector for each light beam that detects the reflected light from the corresponding illumination spot. FIG. 2 illustrates an exemplary signal from each detector. As shown for the signal for a first detector corresponding to the first illumination spot, the initial and trailing edges of the first barcode may be detected at times t₁ and t₂, respectively. Similarly, the signal for a second detector corresponding to the second illumination spot will also detect the initial and trailing edges of the first bar code at subsequent times t₃ and t₄, respectively. Because a distance d between the illumination spots is known, the normally-directed velocity of the scan with regard to the detection of the initial edge of the first barcode may be determined from the difference in time between times t₁ and t₂ of FIG. 2. The velocity of the scan at this edge is given by the known distance d between the illumination spots divided by the time difference (t₂-t₁). Given the scan velocity, the widths of the bars and the unprinted media strips may be readily determined as known in the art.

In general, barcode verifiers are machine scanned such that the scan velocity does not change as the barcode is verified. However, a handheld barcode verifier will invariably involve some velocity change as the barcode is verified. U.S. Pat. No. 4,705,939 discloses an averaging technique in which time differences of the initial edge detections and the trailing edge detections are used to account for velocity changes. However, even with this averaging, inaccuracies may remain with regard to barcode width determinations.

Accordingly, there is a need in the art for an improved barcode verifier adapted for handheld use.

### SUMMARY

In accordance with an aspect of the invention, a method of estimating barcode widths and spaces using a first light source separated by a known distance from a second light source is provided. The method comprises: scanning the first and second laser sources over a barcode while detecting a corresponding first reflected light beam and a second reflected light beam from the scanned barcode; processing the first reflected light beam to determine first barcode edge detections; processing the second reflected light beam to determine second barcode edge detections; estimating a first acceleration for the scanning; estimating a second acceleration for the scanning, wherein the second acceleration is substantially orthogonal to the first acceleration; deriving an overall velocity for the scanning by integrating the first and second accelerations; and comparing the first edge detections to the second edge detections using the overall velocity to derive the barcode widths and spaces.

In accordance with another aspect of the invention, a barcode verifier apparatus is provided that includes; a first photodetector; a second photodetector separated from the first photodetector by a known distance along a first axis; a first accelerometer arranged to detect an acceleration along the first axis; and a second accelerometer arranged to detect, an acceleration along a second axis substantially orthogonal to the first axis.

In accordance, with another aspect of the invention, a barcode verifier is provided that includes; means for determining accelerations during a barcode scan; and means for using the determined accelerations and detected barcode edges from the barcode scan for determining barcode widths and barcode space widths.

### BRIEF DESCRIPTION OF THE DRAWINGS

FIG. 1 illustrates two barcode verification illumination spots about to scan across a barcode to be verified.

FIG. 2 is a graphical representation of corresponding detector signals as the barcodes of FIG. 1 is illuminated by the two barcode illumination spots.

FIG. 3 illustrates a typical handheld verification scan of a barcode.

FIG. 4 illustrates a barcode verifier including an x-directed accelerometer and a y-directed accelerometer.

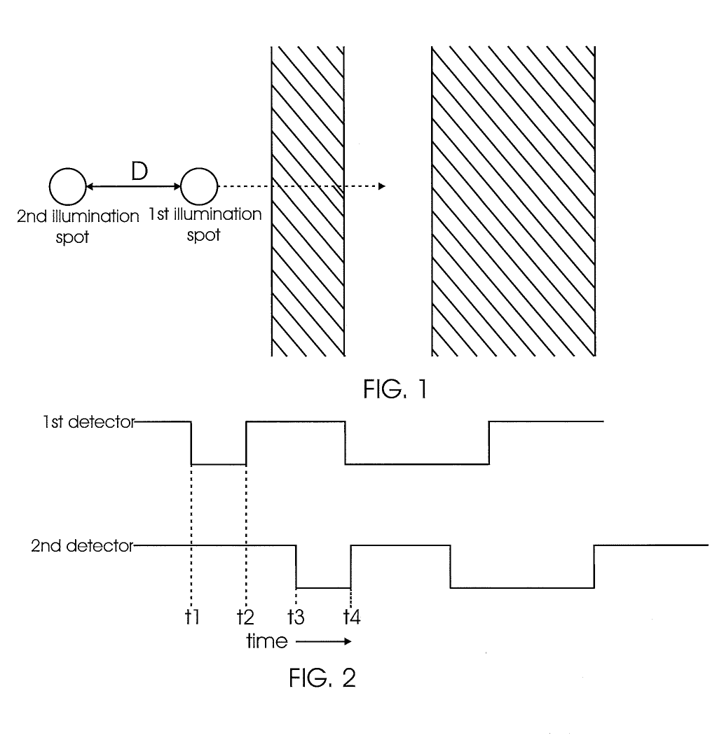

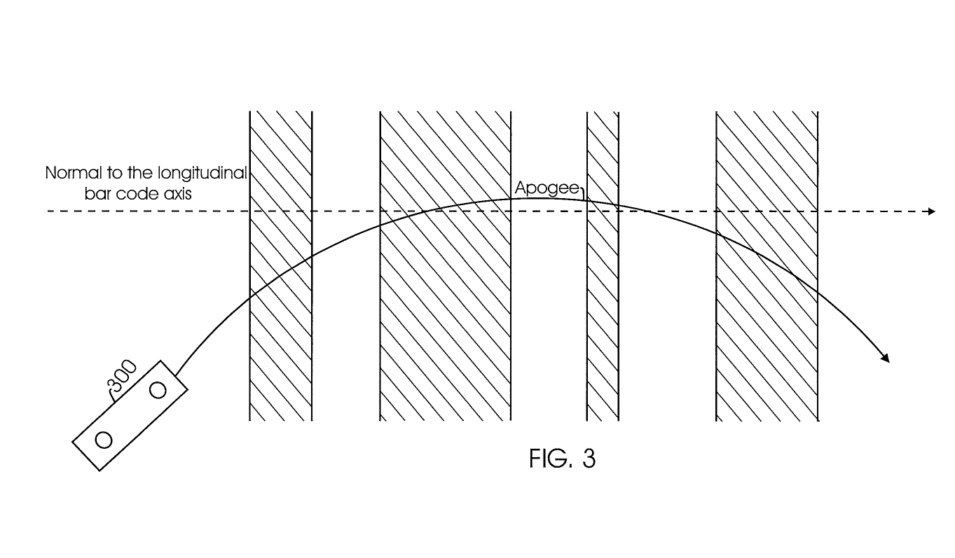

### DETAILED DESCRIPTION

Reference will now be made in detail to one or more embodiments of the invention. While the invention will be described with respect to these embodiments, it should be understood that the invention is not limited to any particular embodiment. On the contrary, the invention includes alternatives, modifications, and equivalents as may come within the spirit and scope of the appended claims. Furthermore, in the following description, numerous specific details are set forth to provide a thorough understanding of the invention. The invention may be practiced without some or all of these specific details. In other instances, well-known structures and principles of operation have not been described in detail to avoid obscuring the invention.

FIG. 3 illustrates a natural path for a handheld barcode verification scan. As discussed earlier, a barcode verifier uses at least two illumination spots, which are generated in FIG. 3 at either end of a housing 300. A linear vector drawn between the two illumination spots should be normally directed to the longitudinal axis of the bars in the barcode to be verified. However, a natural path for a handheld scan is slightly arched, which is exaggerated in FIG. 3 for illustration purposes. Even if the user maintained the same speed through such an arc, the determination of the bar widths (and also widths for the unprinted media strips will be underestimated in the initial and final stages of the scan. Only in the center of the scan, where a normally-directed linear path is briefly taken, would the change in attitude of the scan not affect width determinations. But even during this scan portion, a human operator may inevitably introduce some velocity variations.

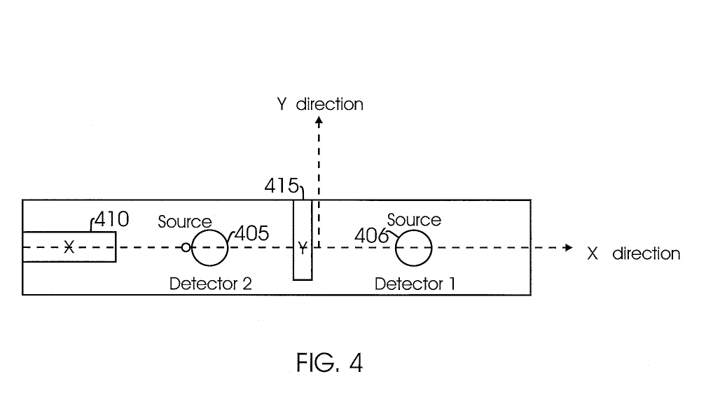

To account for the velocity changes (which could also occur in even machine-directed scans), at least two accelerometers are integrated with the housing for the two light sources. It will be appreciated, however, that additional light sources and/or accelerometers may be integrated with the disclosed acceleration-corrected barcode verifier. Turning now to FIG. 4, the vector through light sources 400 and 405 (which produce corresponding illumination spots on the barcode to be verified) is denoted as the x direction. The light sources may comprise laser sources, LED sources, or other suitable light sources for the bar code arts. The normal direction is denoted as the y direction. An x-directed accelerometer 410 detects acceleration in the x-direction. A y-directed accelerometer 415 detects acceleration in the y-direction.

Note the advantages of such an arrangement of accelerometers. The resulting accelerations from accelerometers 410 and 415 may be integrated to obtain the y-direction velocity as well as the x-direction velocity. Based upon these velocities, the detected barcode widths may be adjusted. For example, consider a hypothetical case in which the barcode widths are presumed to be the same, for example, 9 units of width each (the unit being arbitrary such as centimeters, inches, etc.). If the scan direction is arched such as shown in FIG. 3, a conventional (non-acceleration-corrected) barcode verification scheme would detect an initial barcode as being thin, a subsequent bar code as being slightly thicker, and so on. The thickest barcode detections would be at the top of the arch where the instantaneous velocity is x-directed. For example, if 5 identical barcodes having a width of 9 units each are scanned in this fashion, an exemplary width determination may be presumed to register as 5, 7, 9, 7, and 5 units in width, respectively. In other words, the first barcode encountered during the scan would be deemed to be five units in width, a second barcode would be deemed to be seven units in width, and so on. With reference to FIG. 3, this width detection uses a velocity determined from the time difference between the two detectors detecting the same barcode edge using the known separation D between the detectors/illumination spots. For example, a velocity V at the detection of the first barcode edge is given by D/(t₃-t₁). Given this velocity, the first barcode width would be given by V*(t₂-t₁). Alternatively, the first barcode width would be given by V*(t₂-t₄). Because such calculations assume that the velocity is constant, a more accurate barcode width may be determined using an average velocity from multiple barcode edge detections as known in the art.

Regardless of how many barcode edge detections are used in a conventional barcode verification scheme, the assumption is that the velocity is purely x-directed (i.e., normal to the longitudinal axis of the barcodes). This assumption is particularly subject to error for a handheld barcode scan as discussed with regard to FIG. 3. However, the accelerometers shown in FIG. 4 allow a barcode verifier to correct this assumption through integration of the accelerations provided by the accelerometers. For example, suppose that the integration of an acceleration a_{y} from accelerometer 415 between times t₂ and t₁ (of FIG. 3) provides a velocity v_{y} of 1.5 whereas an integration of an acceleration aₓ from accelerometer 410 between these same times provides a velocity vₓ of 1.4. Given these x and y velocities, an overall velocity Rv may be calculated as the square root of the quantity (vₓ² and v_{y}²), which equals 2. Referring back to the exemplary barcode width determination for five equally-sized barcodes of 5, 7, 9, 7, and 5, it may be assumed that the vₓ and v_{y} were 1.4 and 1.5, respectively for the first two barcodes. For the middle (third) barcode, v_{y} is determined to be zero and vₓ found to be 2. Finally, the velocities vₓ and v_{y} for the last two barcodes are 1.5 and −1.5, respectively. Given these velocities, it may be seen that the width determination for the second barcode and fourth barcodes must be incremented by two. Similarly, the width determination for the first and fifth barcodes must be incremented by four such that the acceleration-corrected barcode widths becomes 9, 9, 9, 9, and 9, thereby accurately reflecting their a priori widths.

The above-described embodiments of the present invention are merely meant to be illustrative and not limiting. It will thus be obvious to those skilled in the art that various changes and modifications may be made without departing from this invention in its broader aspects. Therefore, the appended claims encompass all such changes and modifications as fall within the true spirit and scope of this invention.

What is claimed is:

1. A method of estimating barcode widths and barcode space widths using a first light source separated by a known distance from a second light source, comprising:
scanning the first and second light sources over a barcode while detecting a corresponding first, reflected light beam and a second reflected light beam from the scanned barcode;
processing the first reflected light beam to determine first barcode edge detections;
processing the second reflected light beam to determine second barcode edge detections;
estimating a first acceleration for the scanning;
estimating a second acceleration for the scanning, wherein the second acceleration is substantially orthogonal to the first acceleration;
deriving an overall velocity for the scanning using first and second accelerations; and
comparing the first edge detections to the second edge detections using the overall velocity to derive the barcode widths and barcode space widths.

2. The method of claim 1, wherein the first and second accelerations are estimated using orthogonally-arranged accelerometers.

3. The method of claim 1, wherein deriving the overall velocity comprises:
integrating the first acceleration to provide a first velocity;
integrating the second acceleration to provide a second velocity;
squaring the first velocity to provide a first square;
squaring the second velocity to provide a second square;
summing the first and second squares to provide a sum; and
taking the square root of the sum to provide the overall velocity.

4. The method of claim 1, wherein the scanning comprises manual scanning.

5. The method of claim 1, wherein the scanning comprises machine scanning.

6. A barcode verifier apparatus, comprising;
a first photodetector;
a second photodetector separated from the first photodetector by a known distance along a first axis;
a first accelerometer arranged to detect an acceleration along the first axis; and a
a second accelerometer arranged to detect an acceleration along a second axis substantially orthogonal to the first axis.

7. The barcode verifier apparatus of claim 6, further comprising: a first light source arranged to direct a light beam at a scanned barcode such that a first reflected light may be detected by the first photodetector; and a second light source arranged to direct a light beam at the scanned barcode such that a second reflected light may be detected by the second photodetector.

8. The barcode verifier apparatus of claim 6, further comprising a processor adapted to integrate an acceleration from each of the accelerometers so as to determine a first velocity along the first axis and a second velocity along the second axis.

9. The barcode verifier apparatus of claim 8, wherein the processor is further adapted to determine an overall velocity from the first and second velocities.

10. The barcode verifier apparatus of claim 9, wherein the processor is further adapted to determine barcode widths and barcode space widths using the overall velocity.

11. The barcode verifier apparatus of claim 6, wherein the first and second light sources comprise laser sources.

12. The barcode verifier apparatus of claim 6, wherein the first and second light sources comprise LED sources.

13. A barcode verifier, comprising;
means for determining accelerations during a barcode scan; and
means for using the determined accelerations and detected barcode edges from the barcode scan for determining barcode widths and barcode space widths for a scanned barcode.

14. The barcode verifier of claim 13, wherein the means for determining accelerations during a barcode scan comprises an accelerometer.

15. The barcode verifier of claim 14, wherein the means for determining accelerations comprises a first accelerometer and a second accelerometer.

16. The barcode verifier of claim 15, wherein the first accelerometer and the second accelerometer are arranged to detect substantially orthogonal accelerations.

17. The barcode verifier of claim 16, further comprising:
a first photodetector; and
a second photodetector separated from the first photodetector by a known distance along a first axis, wherein the first accelerometer is arranged to determine an acceleration along the first axis.

18. The barcode verifier of claim 17, further comprising; a first light source adapted to provide a reflected light from the barcode to the first photodetector and a second light source adapted to provide a reflected light from the barcode to the second photodetector.

19. The barcode verifier of claim 18, wherein the first and second light sources comprise laser sources.

20. The barcode verifier of claim 18, wherein the first and second light sources comprise LED sources.
